(19) United States
(12) Patent Application Publication
(10) Pub. No.: US 2025/0139802 A1
(43) Pub. Date: May 1, 2025

(54) IMAGE PROCESSOR AND IMAGE PROCESSING SYSTEM INCLUDING THE SAME

(71) Applicant: SK hynix Inc., Gyeonggi-do (KR)

(72) Inventor: Ji Hee HAN, Gyeonggi-do (KR)

(21) Appl. No.: 18/656,595

(22) Filed: May 7, 2024

(30) Foreign Application Priority Data
Oct. 31, 2023 (KR) 10-2023-0147804

(51) Int. Cl. G06T 7/55; G06T 7/13; H04N 25/704

(52) U.S. Cl. CPC G06T 7/55; G06T 7/13; H04N 25/704; G06T 2207/20212

(57) ABSTRACT

Disclosed is an image processor and an image processing system including the same. The image processor may include a first depth map generator configured to generate a first depth map having a first depth range corresponding to a first distance, based on first image values; a second depth map generator configured to generate a second depth map having a second depth range corresponding to a second distance longer than the first distance, based on the first image values and second image values; and a third depth map generator configured to combine the first depth map and the second depth map to generate a third depth map having a third depth range corresponding to the first and second distances.

### CROSS-REFERENCE TO RELATED APPLICATION(S)

This application claims priority under 35 U.S.C. § 119 to Korean Patent Application No. 10-2023-0147804, filed on Oct. 31, 2023, the disclosure of which is incorporated herein by reference in its entirety.

### BACKGROUND

### 1. Field

Various embodiments of the present disclosure relate to a

semiconductor design technique, and more particularly, to an image processor that generates a depth map, and an image processing system including the image processor and image sensors.

### 2. Description of the Related Art

Image sensors are devices for capturing images using the property of a semiconductor which reacts to light. Image sensors may be roughly classified into charge-coupled device (CCD) image sensors and complementary metal-oxide semiconductor (CMOS) image sensors. Recently, CMOS image sensors are widely used because the CMOS image sensors can allow both analog and digital control circuits to be directly implemented on a single integrated circuit (IC).

An image processor may generate a depth map on the basis of an image captured by an image sensor. However, when the depth map is generated using only an image generated through a single image sensor, a depth range of the depth map may be limited.

### SUMMARY

Various embodiments of the present disclosure are directed to an image processor capable of generating a depth map with a wider depth range, and an image processing system including the image processor.

In accordance with an embodiment of the present disclosure, an image processor may include: a first depth map generator configured to generate a first depth map having a first depth range corresponding to a first distance, based on first image values; a second depth map generator configured to generate a second depth map having a second depth range corresponding to a second distance longer than the first distance, based on the first image values and second image values; and a third depth map generator configured to combine the first depth map and the second depth map to generate a third depth map having a third depth range corresponding to the first and second distances.

In accordance with an embodiment of the present disclosure, first and second image sensors configured to capture first and second scenes having a predetermined time difference therebetween, respectively, and generate first image values corresponding to first images obtained by capturing the first scene and second image values corresponding to second images obtained by capturing the second scene, respectively; and an image processor configured to generate a depth map based on the first image values and the second image values by using at least one of the first image values and the second image values for each kernel according to distances of subjects included in the captured images.

In accordance with an embodiment of the present disclosure, an image processing method may include: capturing first and second scenes having a predetermined time difference therebetween; generating first image values corresponding to first images obtained by capturing the first scene and second image values corresponding to second images obtained by capturing the second scene, respectively; generating a first depth map having a first depth range corresponding to a first distance, based on first image values; generating a second depth map having a second depth range corresponding to a second distance longer than the first distance, based on the first image values and second image values; and combining the first depth map and the second depth map to generate a third depth map having a third depth range corresponding to the first and second distances.

### BRIEF DESCRIPTION OF THE DRAWINGS

FIG. 1 is a block diagram illustrating an image processing system in accordance with an embodiment of the present invention.

FIG. 2 is a detailed block diagram illustrating an image sensor illustrated in FIG. 1.

FIG. 3 is a schematic diagram illustrating an example of a pixel array illustrated in FIG. 2.

FIG. 4 is a detailed block diagram illustrating an image processor illustrated in FIG. 1.

FIG. 5 is a detailed block diagram illustrating an example of a first depth map generator illustrated in FIG. 4.

FIG. 6 is a detailed block diagram illustrating an example of a first processor illustrated in FIG. 5.

FIG. 7 is a detailed block diagram illustrating an example of a second processor illustrated in FIG. 5.

FIG. 8 is a detailed block diagram illustrating an example of a third processor illustrated in FIG. 5.

FIG. 9 is a detailed block diagram illustrating an example of a second depth map generator illustrated in FIG. 4.

FIG. 10 is a detailed block diagram illustrating an example of a fourth processor illustrated in FIG. 9.

FIG. 11 is a detailed block diagram illustrating an example of a fifth processor illustrated in FIG. 9.

FIG. 12 is a detailed block diagram illustrating an example of a sixth processor illustrated in FIG. 9.

FIGS. 13 to 16 are diagrams illustrating an operation of an image processing system in accordance with an embodiment of the preset disclosure.

### DETAILED DESCRIPTION

Various embodiments of the present disclosure are described below with reference to the accompanying drawings, in order to describe in detail the embodiments of the present disclosure so that those with ordinary skill in art to which the present disclosure pertains may easily carry out the technical spirit of the present disclosure.

It will be understood that when an element is referred to as being “connected to” or “coupled to” another element, the element may be directly connected to or coupled to the another element, or electrically connected to or coupled to the another element with one or more elements interposed therebetween. In addition, it will also be understood that the terms “comprises,” “comprising,” “includes,” and “including” when used in this specification do not preclude the presence of one or more other elements but may further include or have the one or more other elements, unless otherwise mentioned. In the description throughout the specification, some components are described in singular forms, but the present disclosure is not limited thereto, and it will be understood that the components may be formed in plural.

FIG. 1 is a block diagram illustrating an image processing system 10 together with subjects 20 in accordance with an embodiment of the present invention.

Referring to FIG. 1, the image processing system 10 may include a first image sensor 100, a second image sensor 200, and an image processor 300.

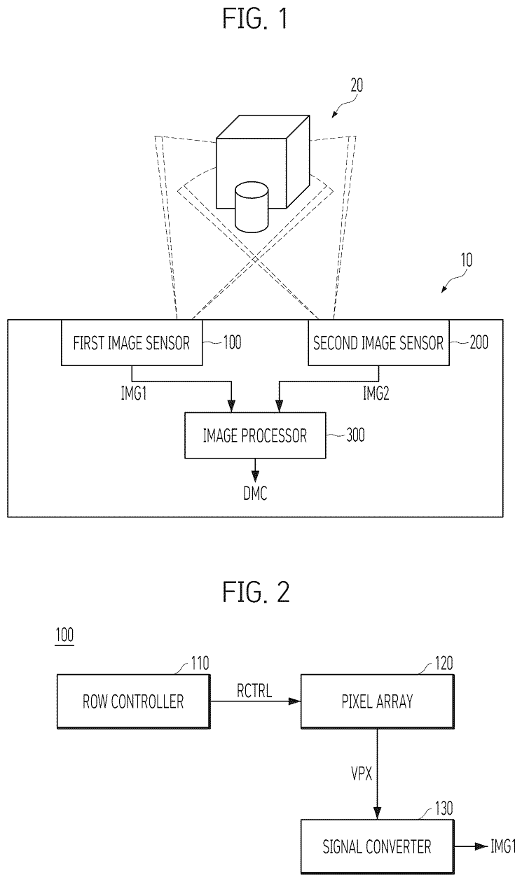

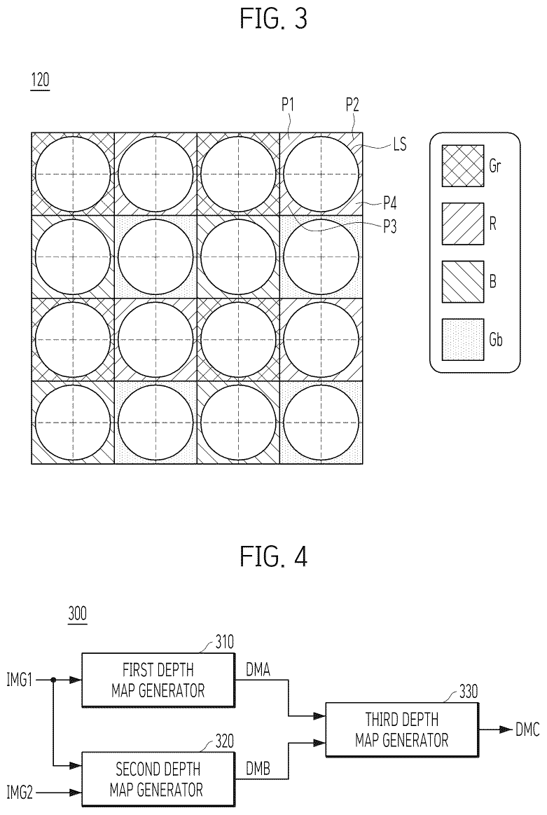

The first image sensor 100 and the second image sensor 200 may capture first and second scenes having a predetermined time difference therebetween, respectively, and generate first image values IMG1 corresponding to a first image obtained by capturing the first scene and second image values IMG2 corresponding to a second image obtained by capturing the second scene, respectively. The first and second image sensors 100 and 200 may be disposed spaced apart from each other by a predetermined baseline. The baseline may be a distance between an optical axis of the first image sensor 100 and an optical axis of the second image sensor 200. The first and second image sensors 100 and 200 may be the same type of image sensors (refer to FIGS. 2 and 3).

The image processor 300 may generate a depth map DMC on the basis of the first image values IMG1 and the second image values IMG2. In particular, the image processor 300 may generate the depth map DMC by using the first image values IMG1 and/or the second image values IMG2 for each kernel according to a distance of the subjects 20 included in the captured images.

FIG. 2 is a detailed block diagram illustrating the first image sensor 100 illustrated in FIG. 1.

Referring to FIG. 2, the first image sensor 100 may include a row controller 110, a pixel array 120, and a signal converter 130.

The row controller 110 may generate row control signals RCTRL for controlling the pixel array 120 for each row. For example, the row controller 110 may generate first row control signals for controlling pixels arranged in a first row of the pixel array 120 and y^{th} row control signals for controlling pixels arranged in an y^{th} row of the pixel array 120, where “y” is a natural number greater than 1. The first and y^{th} row control signals may be included in the row control signals RCTRL.

The pixel array 120 may include a plurality of pixels arranged in row and column directions. The plurality of pixels may be arranged in a quad pattern (refer to FIG. 3). The pixel array 120 may generate pixel values VPX corresponding to incident light for each row, in response to the row control signals RCTRL. For example, the pixel array 120 may generate the pixel values VPX from the pixels arranged in the first row during a first row time and generate the pixel values VPX from the pixels arranged in the y^{th} row during an y^{th} row time. Each of the pixel values VPX may be an analog-type pixel value.

The signal converter 130 may convert the analog-type pixel values VPX into digital-type first image values IMG1. For example, the signal converter 130 may include an analog to digital converter.

FIG. 3 is a schematic diagram illustrating an example of the pixel array 120 illustrated in FIG. 2.

Referring to FIG. 3, the pixel array 120 may include the plurality of pixels arranged in the quad pattern. Each of the plurality of pixels may be a pixel for phase detection auto focus. The quad pattern may have a structure in which four pixels having the same color filter are arranged in 2×2 and a color arrangement is repeated in a 4×4 unit. The 4×4 unit may correspond to a Bayer pattern.

According to one example, the quad pattern may have a structure in which four pixels each having a green color filter Gr are arranged in 2×2 in an upper left position, four pixels each having a red color filter R are arranged in 2×2 in an upper right position, four pixels each having a blue color filter B are arranged in 2×2 in a lower left position, and four pixels each having a green color filter Gb are arranged in 2×2 in a lower right position.

The pixel array 120 may include a plurality of micro lenses. The plurality of micro lenses may be disposed on top of the plurality of pixels. The plurality of micro lenses and the plurality of pixels may be disposed in a one-to-many relationship. For example, four (i.e., 2×2) pixels P1, P2, P3, and P4 per one micro lens LS may be disposed. As the four pixels P1, P2, P3, and P4 are disposed under the one micro lens LS, four (i.e., top/bottom/left/right) disparity values may be obtained on the basis of four pixel values generated from the four pixels P1, P2, P3, and P4. The four disparity values may be used when a depth map of a subject located at a close range among the subjects 20 is generated.

Since the second image sensor 200 may be configured in the same structure as the first image sensor 100, a detailed description of the second image sensor 200 is omitted.

FIG. 4 is a detailed block diagram illustrating the image processor 300 illustrated in FIG. 1.

Referring to FIG. 4, the image processor 300 may include a first depth map generator 310, a second depth map generator 320, and a third depth map generator 330.

The first depth map generator 310 may generate a first depth map DMA on the basis of the first image values IMG1. The first depth map DMA may be generated on the basis of the first image values IMG1, and thus have a first depth range corresponding to a relatively short distance.

The second depth map generator 320 may generate a second depth map DMB on the basis of the first image values IMG1 and the second image values IMG2. The second depth map DMB may be generated on the basis of the first and second image values IMG1 and IMG2, and thus have a second depth range corresponding to a relatively long distance. The second depth range may be related to the baseline between the first and second image sensors 100 and 200, and the second depth range may become wider as the baseline becomes longer. That is, the second depth range and the baseline have a proportional relationship.

The third depth map generator 330 may generate the depth map DMC by combining the first depth map DMA and the second depth map DMB. The depth map DMC may have a third depth range corresponding to the short and long distances. Specifically, the third depth map generator 330 may generate the depth map DMC by using at least one of the first depth map DMA and the second depth map DMB for each kernel according to the distance of the subjects 20 included in the captured image. For example, the third depth map generator 330 may generate the depth map DMC by using at least one of the first depth map DMA and the second depth map DMB according to a first variation value of a confidence level corresponding to the first depth map DMA and a second variation value of a confidence level corresponding to the second depth map DMB for each kernel. When a difference value between the first variation value and the second variation value is less than or equal to a predetermined reference value, the third depth map generator 330 may use an average depth map of the first depth map DMA and the second depth map DMB. The average depth map may have a depth range corresponding to an intermediate distance between the short distance and the long distance. Otherwise, when the difference value between the first variation value and the second variation value is greater than the predetermined reference value, the third depth map generator 330 may use a depth map having a lesser variation value, among the first depth map DMA and the second depth map DMB.

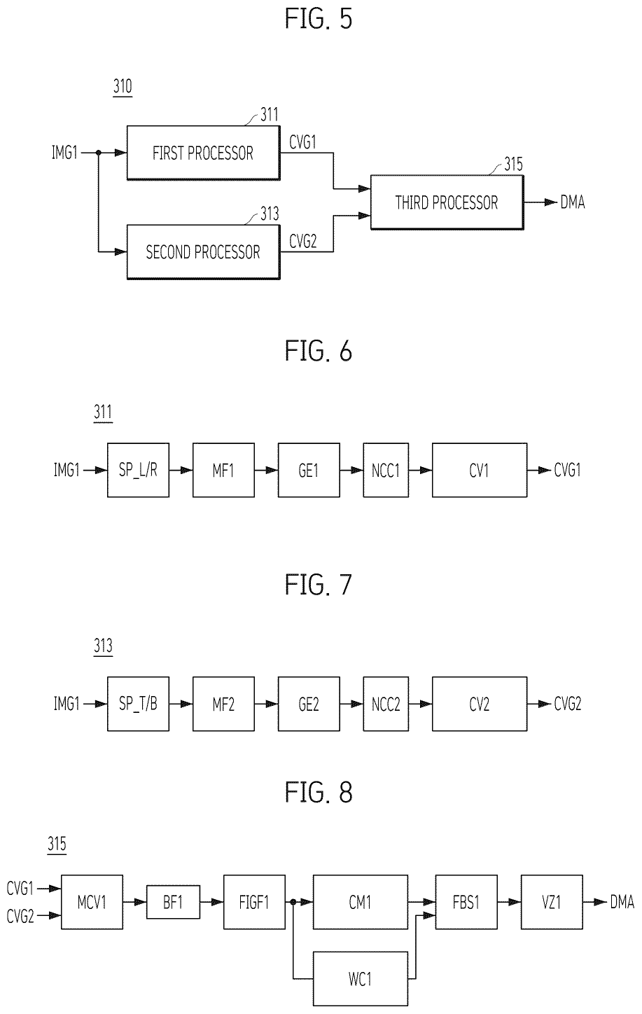

FIG. 5 is a detailed block diagram illustrating an example of the first depth map generator 310 illustrated in FIG. 4.

Referring to FIG. 5, the first depth map generator 310 may include first to third processors 311, 313, and 315.

The first processor 311 may generate first processing values CVG1 corresponding to a first gradient, on the basis of image values corresponding to a binocular time difference in a horizontal direction, among the first image values IMG1.

The second processor 313 may generate second processing values CVG2 corresponding to a second gradient, on the basis of image values corresponding to a binocular time difference in a vertical direction, among the first image values IMG1.

The third processor 315 may generate the first depth map DMA on the basis of the first processing values CVG1 and the second processing values CVG2.

FIG. 6 is a detailed block diagram illustrating an example of the first processor 311 illustrated in FIG. 5.

Referring to FIG. 6, the first processor 311 may include a first sampling unit SP_L/R, a first mean filtering unit MF1, a first gradient extraction unit GE1, a first similarity measurement unit NCC1, and a first generation unit CV1.

The first sampling unit SP_L/R may sample image values corresponding to the “left” and image values corresponding to the “right”, among the first image values IMG1. For example, the image values corresponding to the left (hereinafter referred to as a “left image”) may correspond to pixels P1 and P3 disposed on the left, among the four (i.e., 2×2) pixels P1, P2, P3, and P4, and the image values corresponding to the right (hereinafter referred to as a “right image”) may correspond to pixels P2 and P4 disposed on the right, among the four (i.e., 2×2) pixels P1, P2, P3, and P4.

The first mean filtering unit MF1 may take charge of smoothing the left image and the right image through a noise reduction operation. The first mean filtering unit MF1 does not necessarily need to be configured.

The first gradient extraction unit GE1 may extract an edge component of the left image and an edge component of the right image. The edge component of the left image and the edge component of the right image may be used to find a disparity between the left image and the right image.

The first similarity measurement unit NCC1 may measure a similarity between the left image and the right image on the basis of the edge component of the left image and the edge component of the right image and generate first measurement values corresponding to the measurement result. For example, the first similarity measurement unit NCC1 may use a normalized cross correlation (NCC) method.

The first generation unit CV1 may generate the first processing values CVG1 in a 3D (dimension) form by merging the measurement values for each disparity on the basis of the first measurement values.

FIG. 7 is a detailed block diagram illustrating an example of the second processor 313 illustrated in FIG. 5.

Referring to FIG. 7, the second processor 313 may include a second sampling unit SA_T/B, a second average filtering unit MF2, a second gradient extraction unit GE2, a second similarity specification unit NCC2, and a second generation unit CV2.

The second sampling unit SP_T/B may sample image values corresponding to the “top” and image values corresponding to the “bottom”, among the first image values IMG1. For example, the image values corresponding to the top (hereinafter referred to as a “top image”) may correspond to pixels P1 and P2 disposed on the upper side, among the four (i.e., 2×2) pixels P1, P2, P3, and P4, and the image values corresponding to the bottom (hereinafter referred to as a “bottom image”) may correspond to pixels P3 and P4 disposed on the lower side, among the four (i.e., 2×2) pixels P1, P2, P3, and P4.

The second mean filtering unit MF2 may take charge of smoothing the top image and the bottom image through a noise reduction operation. The second mean filtering unit MF2 does not necessarily need to be configured.

The second gradient extraction unit GE1 may extract an edge component of the top image and an edge component of the bottom image. The edge component of the top image and the edge component of the bottom image may be used to find a disparity between the top image and the bottom image.

The second similarity measurement unit NCC2 may measure a similarity between the top image and the bottom image on the basis of the edge component of the top image and the edge component of the bottom image and generate second measurement values corresponding to the measurement result. For example, the second similarity measurement unit NCC2 may use a normalized cross correlation (NCC) method.

The second generation unit CV2 may generate the second processing values CVG2 in a 3D (dimension) form by merging the measurement values for each disparity on the basis of the second measurement values.

FIG. 8 is a detailed block diagram illustrating an example of the third processor 315 illustrated in FIG. 5.

Referring to FIG. 8, the third processor 315 may include a first combining unit MCV1, a first box filtering unit BF1, a first guide filtering unit FIGF1, a first confidence level measurement unit CM1, a first deviation correction unit WC1, a first noise filtering unit FBS1, and a first visualization unit VZ1.

The first combining unit MCV1 may merge the first processing values CVG1 and the second processing values CVG2 and generate a first combined image.

The first box filtering unit BF1 may smooth the first combined image and generate a first smoothed image. The first box filtering unit BF1 does not necessarily need to be configured.

The first guide filtering unit FIGF1 may generate a first noise-reduced filtered image on the basis of the first smoothed image (or the first combined image) and a guided image. For example, the first guide filtering unit FIGF1 may include a full image guided filter as one of noise reduction filters.

The first confidence level measurement unit CM1 may check the presence or absence of an edge component in the first image on the basis of the first filtered image. The first confidence level measurement unit CM1 may output a confidence map corresponding to the edge component of the first image, separately from the generation of the first processing values CVG1 and the second processing values CVG2, thereby improving reliability.

The first deviation correction unit WC1 may correct a deviation between a disparity of a center portion of the first filtered image and a disparity of an edge portion of the first filtered image on the basis of the first filtered image and generate the depth map with the corrected deviation.

The first noise filtering unit FBS1 may generate a noise-reduced depth map on the basis of the confidence map and the corrected depth map.

The first visualization unit VZ1 may generate the first depth map DMA, which corresponds to a color map or a gray map, on the basis of the noise-reduced depth map. For example, the first visualization unit VZ1 may generate the first depth map DMA by remapping intensity values of the noise-reduced depth map to a color scale or a gray scale.

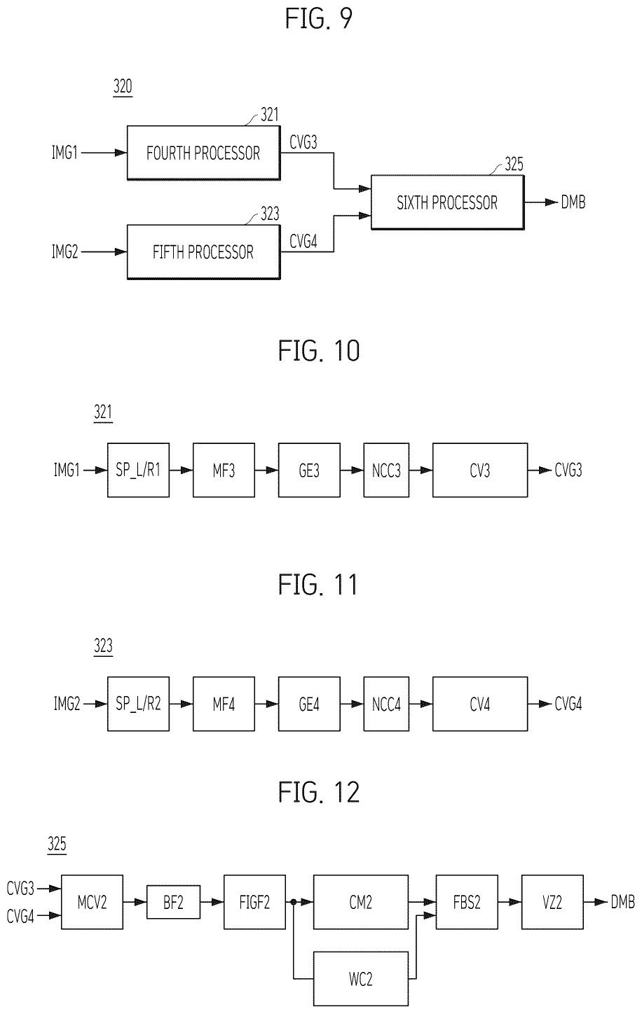

FIG. 9 is a detailed block diagram illustrating an example of the second depth map generator 320 illustrated in FIG. 4.

Referring to FIG. 9, the second depth map generator 320 may include fourth to sixth processors 321, 323, and 325.

The fourth processor 321 may generate third processing values CVG3 corresponding to a third gradient, on the basis of image values corresponding to a binocular time difference in a horizontal direction, among the first image values IMG1.

The fifth processor 323 may generate fourth processing values CVG4 corresponding to a fourth gradient, on the basis of image values corresponding to the binocular time difference in the horizontal direction, among the second image values IMG2.

The sixth processor 325 may generate the second depth map DMB on the basis of the third processing values CVG3 and the fourth processing values CVG4.

FIG. 10 is a detailed block diagram illustrating an example of the fourth processor 321 illustrated in FIG. 9.

Referring to FIG. 10, the fourth processor 321 may include a third sampling unit SP_L/R1, a third mean filtering unit MF3, a third gradient extraction unit GE3, a third similarity measurement unit NCC3, and a third generation unit CV3.

Since the third sampling unit SP_L/R1, the third mean filtering unit MF3, the third gradient extraction unit GE3, the third similarity measurement unit NCC3, and the third generation unit CV3 correspond to the first sampling unit SP_L/R, the first mean filtering unit MF1, the first gradient extraction unit GE1, the first similarity measurement unit NCC1, and the first generation unit CV1, which are illustrated in FIG. 6, respectively, detailed descriptions thereof are omitted.

FIG. 11 is a detailed block diagram illustrating an example of the fifth processor 323 illustrated in FIG. 9.

Referring to FIG. 11, the fifth processor 323 may include a fourth sampling unit SP_L/R2, a fourth mean filtering unit MF4, a fourth gradient extraction unit GE4, a fourth similarity measurement unit NCC4, and a fourth generation unit CV4.

Since the third sampling unit SP_L/R1, the fourth sampling unit SP_L/R2, the fourth mean filtering unit MF4, the fourth gradient extraction unit GE4, the fourth similarity measurement unit NCC4, and the fourth generation unit CV4 correspond to the first sampling unit SP_L/R, the first mean filtering unit MF1, the first gradient extraction unit GE1, the first similarity measurement unit NCC1, and the first generation unit CV1, which are illustrated in FIG. 6, respectively, detailed descriptions thereof are omitted.

FIG. 12 is a detailed block diagram illustrating an example of the sixth processor 325 illustrated in FIG. 9.

Referring to FIG. 12, the sixth processor 325 may include a second combining unit MCV2, a second box filtering unit BF2, a second guide filtering unit FIGF2, a second confidence level measurement unit CM2, a second deviation correction unit WC2, a second noise filtering unit FBS2, and a second visualization unit VZ2. Since the second combining unit MCV2, the second box filtering unit BF2, the second guide filtering unit FIGF2, the second confidence level measurement unit CM2, the second deviation correction unit WC2, the second noise filtering unit FBS2, and the second visualization unit VZ2 may be designed in the same manner as the first combining unit MCV1, the first box filtering unit BF1, the first guide filtering unit FIGF1, the first confidence level measurement unit CM1, the first deviation correction unit WC1, the first noise filtering unit FBS1, and the first visualization unit VZ1, detailed descriptions thereof are omitted.

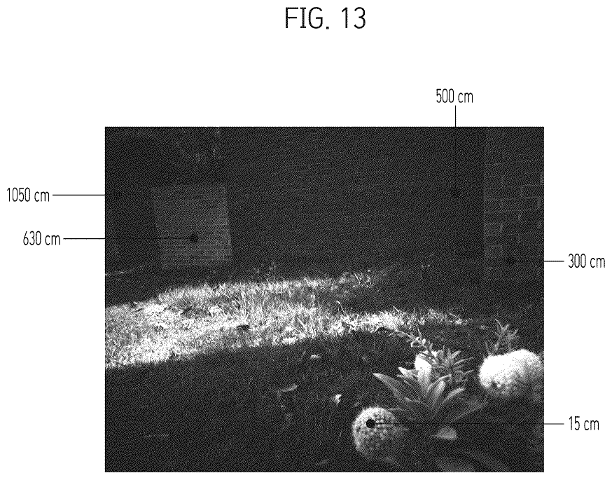

Hereinafter, an operation of the image processing system 10 in accordance with an embodiment of the present disclosure, which has the above-described configuration, is described with reference to FIGS. 13 to 16.

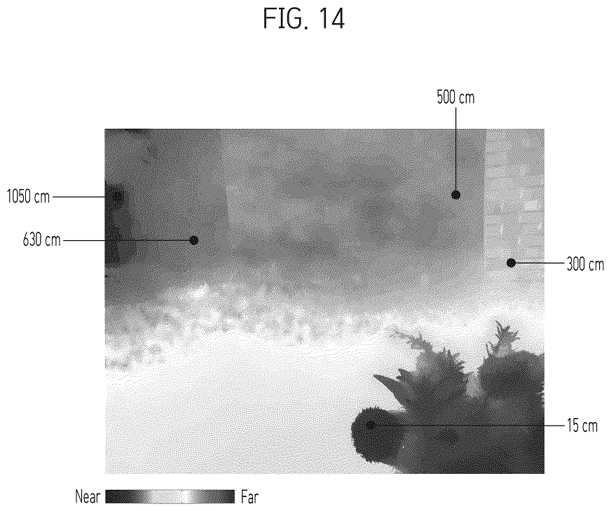

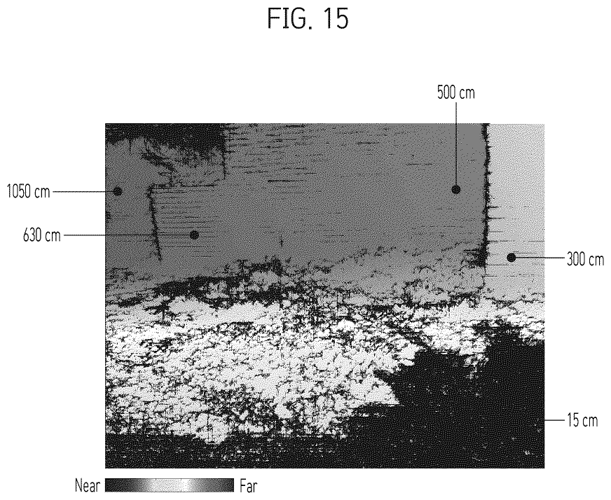

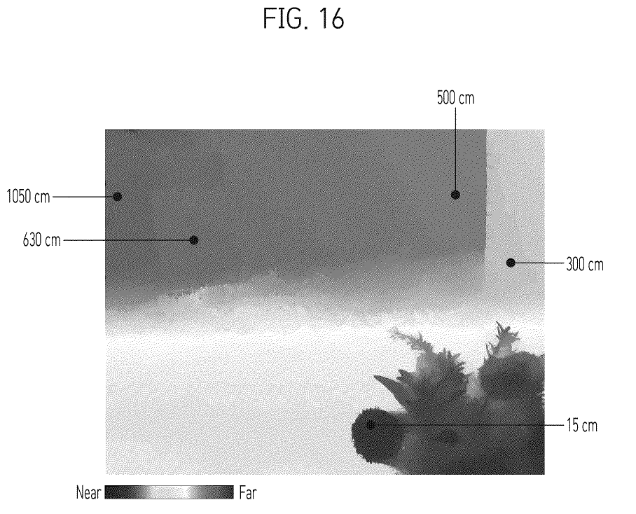

FIG. 13 illustrates a captured image as a color image, FIG. 14 illustrates a first depth map DMA of the captured image, FIG. 15 illustrates a second depth map DMB of the captured image, and FIG. 16 illustrates a depth map DMC of the captured image.

Referring to FIGS. 13 to 16 together, the first image sensor 100 and the second image sensor 200 may capture a first scene and a second scene having a predetermined time difference therebetween, respectively, and generate first image values IMG1 corresponding to a first image (refer to FIG. 13) obtained by capturing the first scene and second image values IMG2 corresponding to a second image (not illustrated) obtained by capturing the second scene, respectively.

The image processor 200 may generate the first depth map DMA on the basis of the first image values IMG1 (refer to FIG. 14) and generate the second depth map DMB on the basis of the first image values IMG1 and the second image values IMG2 (refer to FIG. 15). The image processor 200 may generate the depth map DMC by combining the first depth map DMA and the second depth map DMB (refer to FIG. 16). For example, the depth map DMC may be generated using the first depth map DMA for a short-distance (15 cm) subject for each kernel, be generated using an average depth map of the first and second depth maps DMA and DMB for medium-distance (300 cm, 500 cm, and 630 cm) subjects for each kernel, and be generated using the second depth map DMB for a long-distance (1050 cm) subject for each kernel.

According to an embodiment of the present disclosure, a depth map with a wider depth range may be generated from a short-distance subject to a long-distance subject.

According to an embodiment of the present disclosure, a wider depth range may be secured from a short-distance subject to a long-distance subject, which makes it possible to improve depth accuracy of a depth map.

While the present disclosure has been illustrated and described with respect to specific embodiments, the disclosed embodiments are provided for the description, and not intended to be restrictive. Further, it is noted that the embodiments of the present disclosure may be achieved in various ways through substitution, change, and modification that fall within the scope of the following claims, as those 10 skilled in the art will recognize in light of the present disclosure. The embodiments may be combined to form additional embodiments.

What is claimed is:

1. An image processor comprising:
a first depth map generator configured to generate a first depth map having a first depth range corresponding to a first distance, based on first image values;
a second depth map generator configured to generate a second depth map having a second depth range corresponding to a second distance longer than the first distance, based on the first image values and second image values; and
a third depth map generator configured to combine the first depth map and the second depth map to generate a third depth map having a third depth range corresponding to the first and second distances.

2. The image processor of claim 1, wherein the third depth map generator is configured to generate the third depth map by using at least one of the first depth map and the second depth map for each kernel according to distances of subjects included in a captured image.

3. The image processor of claim 2, wherein the third depth map generator is configured to generate the third depth map by using at least one of the first depth map and the second depth map for each kernel according to a first variation value of a confidence level corresponding to the first depth map and a second variation value of a confidence level corresponding to the second depth map.

4. The image processor of claim 3, wherein the third depth map generator is configured to:
use an average depth map of the first depth map and the second depth map when a difference value between the first variation value and the second variation value is less than or equal to a predetermined reference value; and
use a depth map having a lesser variation value, among the first depth map and the second depth map when the difference value between the first variation value and the second variation value is greater than the predetermined reference value.

5. The image processor of claim 1, wherein the first depth map generator includes:
a first processor configured to generate first processing values corresponding to a first gradient, based on image values corresponding to a binocular time difference in a horizontal direction, among the first image values;
a second processor configured to generate second processing values corresponding to a second gradient, based on image values corresponding to a binocular time difference in a vertical direction, among the first image values; and
a third processor configured to generate the first depth map based on the first processing values and the second processing values.

6. The image processor of claim 1, wherein the second depth map generator includes:
a fourth processor configured to generate third processing values corresponding to a third gradient, based on image values corresponding to a binocular time difference in a horizontal direction, among the first image values;
a fifth processor configured to generate fourth processing values corresponding to a fourth gradient, based on image values corresponding to the binocular time difference in the horizontal direction, among the second image values; and
a sixth processor configured to generate the second depth map based on the third processing values and the fourth processing values.

7. An image processing system comprising:
first and second image sensors configured to capture first and second scenes having a predetermined time difference therebetween, respectively, and generate first image values corresponding to first images obtained by capturing the first scene and second image values corresponding to second images obtained by capturing the second scene, respectively; and
an image processor configured to generate a depth map based on the first image values and the second image values by using at least one of the first image values and the second image values for each kernel according to distances of subjects included in the captured images.

8. The image processing system of claim 7, wherein the first and second image sensors are a same type of image sensors.

9. The image processing system of claim 7, wherein each of the first and second image sensors has a structure in which a plurality of pixels per one lens are disposed, and each of the plurality of pixels includes a pixel for phase detection auto focus.

10. The image processing system of claim 7, wherein the image processor is configured to generate a third depth map by using at least one of a first depth map and a second depth map for each kernel according to a first variation value of a confidence level corresponding to the first depth map and a second variation value of a confidence level corresponding to the second depth map.

11. The image processing system of claim 10, wherein the image processor is configured to
use an average depth map of the first depth map and the second depth map when a difference value between the first variation value and the second variation value is less than or equal to a predetermined reference value; and
use a depth map having a lesser variation value, among the first depth map and the second depth map when the difference value between the first variation value and the second variation value is greater than the predetermined reference value.

12. The image processing system of claim 7, wherein the image processor includes:
a first depth map generator configured to generate a first depth map having a first depth range corresponding to a first distance, based on the first image values;
a second depth map generator configured to generate a second depth map having a second depth range corresponding to a second distance longer than the first distance, based on the first image values and the second image values; and
a third depth map generator configured to combine the first depth map and the second depth map to generate the depth map having a third depth range corresponding to the first and second distances.

13. The image processing system of claim 12, wherein the third depth map generator is configured to generate the depth map by using at least one of the first depth map and the second depth map for each kernel according to the distances of the subjects included in the captured images.

14. The image processing system of claim 13, wherein the third depth map generator is configured to generate the depth map by using at least one of the first depth map and the second depth map for each kernel according to a first variation value of a confidence level corresponding to the first depth map and a second variation value of a confidence level corresponding to the second depth map.

15. The image processing system of claim 14, wherein the third depth map generator is configured to:
use an average depth map of the first depth map and the second depth map when a difference value between the first variation value and the second variation value is less than or equal to a predetermined reference value; and
use a depth map having a lesser variation value, among the first depth map and the second depth map when the difference value between the first variation value and the second variation value is greater than the predetermined reference value.

16. The image processing system of claim 12, wherein the first depth map generator includes:
a first processor configured to generate first processing values corresponding to a first gradient, based on image values corresponding to a binocular time difference in a horizontal direction, among the first image values;
a second processor configured to generate second processing values corresponding to a second gradient, based on image values corresponding to a binocular time difference in a vertical direction, among the first image values; and
a third processor configured to generate the first depth map based on the first processing values and the second processing values.

17. The image processing system of claim 12, wherein the second depth map generator includes:
a fourth processor configured to generate third processing values corresponding to a third gradient, based on image values corresponding to a binocular time difference in a horizontal direction, among the first image values;
a fifth processor configured to generate fourth processing values corresponding to a fourth gradient, based on image values corresponding to the binocular time difference in the horizontal direction, among the second image values; and
a sixth processor configured to generate the second depth map based on the third processing values and the fourth processing values.

18. An image processing method comprising:
capturing first and second scenes having a predetermined time difference therebetween;
generating first image values corresponding to first images obtained by capturing the first scene and second image values corresponding to second images obtained by capturing the second scene, respectively;
generating a first depth map having a first depth range corresponding to a first distance, based on first image values;
generating a second depth map having a second depth range corresponding to a second distance longer than the first distance, based on the first image values and second image values; and
combining the first depth map and the second depth map to generate a third depth map having a third depth range corresponding to the first and second distances.

19. The image processing method of claim 18, wherein the combining of the first depth map and the second depth map comprises generating a depth map based on the first image values and the second image values by using at least one of the first image values and the second image values for each kernel according to distances of subjects included in the captured images.

20. The image processing method of claim 19,
wherein the combining of the first depth map and the second depth map comprises:
using an average depth map of the first depth map and the second depth map when a difference value between a first variation value of a confidence level corresponding to the first depth map and a second variation value of a confidence level corresponding to the second depth map is less than or equal to a predetermined reference value; and
using a depth map having a less variation value, among the first depth map and the second depth map when the difference value between the first variation value and the second variation value is greater than the predetermined reference value.
